(19) United States
(12) Patent Application Publication
(10) Pub. No.: US 2012/0198233 A1
(43) Pub. Date: Aug. 2, 2012

(54) METHOD FOR RECALLING A MESSAGE AND DEVICES THEREOF

(75) Inventors: Robins George, Domlur (IN); Kepeng Li, Shenzhen (CN)

(73) Assignee: HUAWEI TECHNOLOGIES CO., LTD., Shenzhen (CN)

(21) Appl. No.: 13/447,576

(22) Filed: Apr. 16, 2012

Related U.S. Application Data
(63) Continuation of application No. PCT/CN2010/077782, filed on Oct. 15, 2010.

(30) Foreign Application Priority Data
Oct. 16, 2009 (CN) 200910206825.8

(51) Int. Cl. H04L 9/32

(52) U.S. Cl. 713/168

(57) ABSTRACT

A method for recalling a message and a device thereof are provided, thereby efficiently satisfying a message recall demand, and improving a service quality of a message service. The method includes: sending a message recall request to a message receiving device, in which the message recall request carries a message identifier of the message to be recalled and a message authentication header field, and the message authentication header field includes an encryption algorithm and a random number generated by encrypting a random number for authenticating the message through the encryption algorithm, so that the message receiving device determines the message to be recalled according to the message ID and the message authentication header field, and disposes the message to be recalled according to a local policy and a delivery status of the message to be recalled; and receiving a message recall disposition result returned by the message receiving device.

### CROSS-REFERENCE TO RELATED APPLICATIONS

This application is a continuation of International Application No. PCT/CN2010/077782, filed on Oct. 15, 2010, which claims priority to Chinese Patent Application No. 200910206825.8, filed on Oct. 16, 2009, both of which are hereby incorporated by reference in their entireties.

### FIELD OF THE INVENTION

The present invention relates to the field of communications, and in particular, to a method for recalling a message and device thereof.

### BACKGROUND OF THE INVENTION

In the existing mail system and the existing instant message system, after sending a mail, a sending party may find that the mail is sent to an incorrect mail list or an irrelevant person, or content of the mail is incorrect and needs to be modified. In such cases, the sending party wishes that the sent mail can be recalled before the mail is read by a receiving party.

In the case that the mail needs to be recalled, two methods generally exist before. In a first method, by logging into a senior administrator account, mail boxes of all recipients are opened one by one, and the mails to be recalled are deleted one by one. In the first method, the work amount is very large, and individual privacy is involved, so the administrator generally implements this method when the administrator really has no choice. In a second method, an agent runs on a server, searches all mail boxes according to an identifier (ID) number of the mail, and deletes the mails to be recalled. In the second method, one agent needs to be further added, and a large amount of searches are required, so the implementation is also inconvenient.

In the existing private mail system, for example, International Business Machines (IBM) Lotus Notes, a private technical solution is mainly adopted to recall a mail, for example, sending a special message. In this technical solution, it cannot be determined whether a receiving server supports the proprietary protocol and the special message in advance. If the receiving server does not support the proprietary protocol and the special message, a recall request message may be sent to an actual receiving party to indicate that an original message needs to be recalled, and the original message is also received at the same time. Therefore, the private solution cannot solve interconnection and intercommunication of different mail systems. For example, a mail recall function in the Microsoft Outlook system is only a client function. How to implement the recall function depends on specific implementation of a mail server. Generally, the recall may fail, or the expected purpose is not achieved. For example, only strikethrough is used for indicating that the mail is recalled.

Furthermore, it is impossible to define a new port-to-port protocol to implement a message recall function, since the Simple Mail Transfer Protocol (SMTP, referring to the Internet Engineering Task Force (IETF) Request for Comments (RFC) 5321 document) adopts a store-and-forward mechanism to transfer a mail message, and the sending party unlikely contacts the receiving server directly. In practice, the sending party generally cannot identify the receiving server at all.

In general, a mature, complete, open, and intercommunicated message recall solution does not exist in the industry.

### SUMMARY OF THE INVENTION

Embodiments of the present invention provide a method for recalling a message and device thereof, to effectively satisfy a message recall demand and improve a service quality of a message service.

In order to achieve the objectives, the embodiments of the present invention adopt technical solutions as follows.

A method for recalling a message includes:

sending a message recall request to a message receiving device, in which the message recall request carries a message ID of a message to be recalled and a message authentication header field, and the message authentication header field includes an encryption algorithm and a random number generated by encrypting a random number for authenticating the message through the encryption algorithm, so that the message receiving device determines the message to be recalled according to the message ID and the message authentication header field, and disposes the message to be recalled according to a local policy and a delivery status of the message to be recalled; and

receiving a message recall disposition result returned by the message receiving device.

A method for recalling a message includes:

receiving a message recall request, in which the message recall request carries a message ID of a message to be recalled and a message authentication header field, and the message authentication header field includes an encryption algorithm and a random number generated by encrypting a random number for authenticating the message through the encryption algorithm;

determining the message to be recalled according to the message ID and the message authentication header field; and

disposing the message to be recalled according to a local policy and a delivery status of the message to be recalled, and returning a message recall disposition result to a message recall party.

A message sending device includes:

a sending unit, configured to send a message recall request to a message receiving device, in which the message recall request carries a message ID of a message to be recalled and a message authentication header field, and the message authentication header field includes an encryption algorithm and a random number generated by encrypting a random number for authenticating the message through the encryption algorithm, so that the message receiving device determines the message to be recalled according to the message ID and the message authentication header field, and disposes the message to be recalled according to a local policy and a delivery status of the message to be recalled; and

a receiving unit, configured to receive a message recall disposition result returned by the message receiving device.

A message receiving device includes:

a message recall request receiving unit, configured to receive a message recall request, in which the message recall request carries a message ID of a message to be recalled and a message authentication header field, and the message authentication header field includes an encryption algorithm and a random number generated by encrypting a random number for authenticating the message through the encryption algorithm;

a determination unit, configured to determine the message to be recalled according to the message ID and the message authentication header field received by the message recall request receiving unit;

a disposition unit, configured to dispose the message to be recalled according to a local policy and a delivery status of the message to be recalled; and

a disposition result sending unit, configured to return a message recall disposition result disposed by the disposition unit to a message recall party.

Through the technical solution of message recall according to the embodiments of the present invention, a message sending party sends the message recall request to the message receiving device, in which the message recall request carries the message ID of the message to be recalled and the message authentication header field. When receiving the message recall request, the message receiving device determines the message to be recalled according to the message ID and the message authentication header field, acquires the delivery status of the message to be recalled, disposes the message to be recalled according to the local policy and the delivery status of the message to be recalled, and returns the message recall disposition result to the message recall party, so the message recall is implemented, and the message sent by mistake or the message that a user does not want to send can be recalled in time, so that the receiving party may not view the recalled messages, thereby improving a service quality of a message service. Since the message recall request is not limited by a private mail system, each mail system can send and receive the message recall request, so that the message recall demand is satisfied in an open, intercommunicated, and efficient manner, and the message to be recalled can be recalled in time, thereby improving the service quality of the message service.

### BRIEF DESCRIPTION OF THE DRAWINGS

To illustrate the technical solutions according to the embodiments of the present invention or in the prior art more clearly, the accompanying drawings required for describing the embodiments or the prior art are introduced below briefly. Apparently, the accompanying drawings in the following descriptions merely show some of the embodiments of the present invention, and persons of ordinary skill in the art can acquire other drawings according to the accompanying drawings without creative efforts.

FIG. 1 is a flow chart of a method for a message recall sending party in a method for recalling a message according to Embodiment 1 of the present invention;

FIG. 2 is a flow chart of a method for a message recall receiving party in the method for recalling the message according to Embodiment 1 of the present invention;

FIG. 3 is a flow chart of a method for recalling a message according to Embodiment 2 of the present invention, in which the method for recalling the message includes acquiring a delivery status of the message to be recalled based on a message tracking mechanism;

FIG. 4 is a flow chart of a method for recalling a message according to Embodiment 3 of the present invention, in which the method for recalling the message includes acquiring a delivery status of the message to be recalled according to a Delivery Status Notification (DSN) and/or Message Disposition Notification (MDN) mechanism;

FIG. 5 is a block diagram of a message sending device according to Embodiment 4 of the present invention;

FIG. 6 is a block diagram of a message receiving device according to Embodiment 4 of the present invention;

FIG. 7 is a block diagram of a message sending device according to Embodiment 5 of the present invention;

FIG. 8 is a block diagram of a message receiving device according to Embodiment 5 of the present invention; and

FIG. 9 is a block diagram of another message receiving device according to Embodiment 5 of the present invention.

### DETAILED DESCRIPTION OF THE EMBODIMENTS

The technical solutions of the embodiments of the present invention are completely described in the following clearly with reference to the accompanying drawings. Apparently, the embodiments in the following descriptions are merely a part of the embodiments of the present invention, rather than all the embodiments of the present invention. Persons of ordinary skill in the art can derive other embodiments based on the embodiments of the present invention without creative efforts, which all fall within the scope of the present invention.

### Embodiment 1

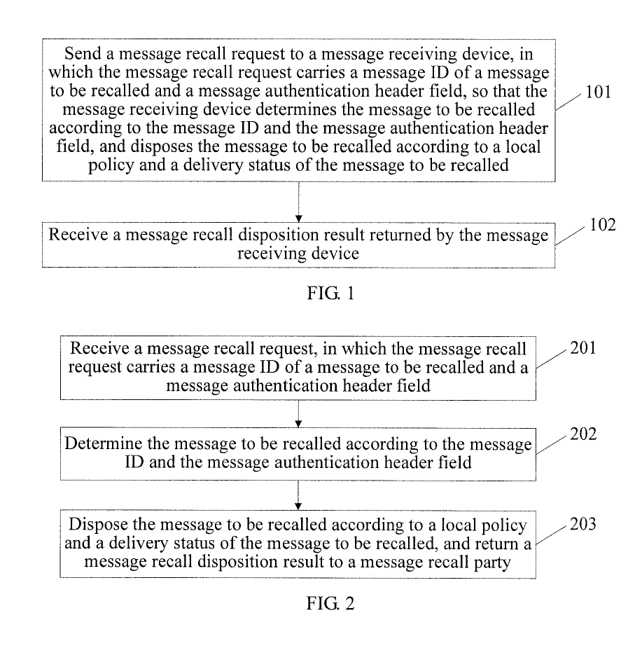

An embodiment of the present invention provides a method for recalling a message. As shown in FIG. 1, the method includes the following steps.

Step 101: Send a message recall request to a message receiving device, in which the message recall request carries a message ID of a message to be recalled and a message authentication header field, and the message authentication header field includes an encryption algorithm and a random number generated by encrypting a random number for authenticating the message through the encryption algorithm, so that the message receiving device determines the message to be recalled according to the message ID and the message authentication header field, and disposes the message to be recalled according to a local policy and a delivery status of the message to be recalled; and the message authentication header field corresponds to a message ID header field, and if a message sending party supports the present invention and wishes that the message sent thereby is recallable, when the sending party sends the message, the message ID header field is included in an original message, and a random number for authenticating the message is saved in the message ID header field.

The message authentication header field may be generated by the sending party or a sending domain server, which can be specifically determined according to a message recall body. The message authentication header field may include the following labels separated by a semicolon “;”, in which no blank space is required between the labels.

Hash=[string]: This field is used for designating an algorithm for generating a Hash value included in a random number field for authenticating the message. The Hash algorithm may be, but is not limited to, SHA1 and SHA256. Any Hash algorithm available for encryption can be used for the field, and the Hash algorithm is not limited in the embodiment of the present invention.

Encrypted data=[base64]: This field is a base64 code of the Hash value of the random number for authenticating the message. The sending party keeps an actual random number of the original message for authenticating the message as a secret. The random number for authenticating the message may be, but is not limited to, a global unique identifier (GUID). Any ID ensuring relative uniqueness of the message can be used in the embodiment of the present invention.

Step 102: Receive a message recall disposition result returned by the message receiving device.

The message recall disposition result may include, but is not limited to, a message recall error, a message recall success, and a message recall failure. When the message recall error is returned, an error reason may also be added, and when the message recall failure is returned, a failure reason may also be added. The form of the message recall disposition result is not limited in the embodiment of the present invention and can be set by a user according to the requirements in a specific embodiment.

An embodiment of the present invention also provides a method for recalling a message. As shown in FIG. 2, the method includes the following steps.

Step 201: Receive a message recall request, in which the message recall request carries a message ID of a message to be recalled and a message authentication header field, and the message authentication header field includes an encryption algorithm and a random number generated by encrypting a random number for authenticating the message through the encryption algorithm. The message authentication header field is specifically described in step 1 in FIG. 1 and is no longer described herein again.

Step 202: Determine the message to be recalled according to the message ID and the message authentication header field, in which in the process of determining the message to be recalled, the message to be recalled is identified according to the message ID first, and after the message to be recalled is identified, it is further determined whether the identified message is the message to be recalled according to the message authentication header field.

Step 203: Dispose the message to be recalled according to a local policy and a delivery status of the message to be recalled, and return a message recall disposition result to a message recall party.

Message servers generally set the local policy. Some servers support a message recall function, and other servers do not support the message recall function. The servers supporting the message recall function may set various limits to specify in which status the message can be recalled. Therefore, a message receiving device needs to dispose the message to be recalled according to the local policy and the delivery status of the message to be recalled.

In the embodiment of the present invention, a message sending party sends the message recall request to the message receiving device, in which the message recall request carries the message ID of the message to be recalled and the message authentication header field. When receiving the message recall request, the message receiving device determines the message to be recalled according to the message ID and the message authentication header field, acquires the delivery status of the message to be recalled, disposes the message to be recalled according to the local policy and the delivery status of the message to be recalled, and returns the message recall disposition result to the message recall party, so message recall is implemented, and the message sent by mistake can be recalled in time, so that a receiving party may not view the recalled messages, thereby improving a service quality of a message service.

### Embodiment 2

After a sending party sends messages, some messages may be opened and read by a receiving party. The message cannot be recalled in this status. At this time, if a message recall request is sent to a message receiving device, the message cannot be recalled. Therefore, in an embodiment of the present invention, before the message recall request is sent to the message receiving device, a delivery status of a message to be recalled is acquired, and it is determined which message receiving devices the message recall request is sent to according to the delivery status of the message, thereby avoiding sending the recall request for some messages impossible to be successfully recalled, and increasing a success rate of message recall. The following two methods for acquiring the delivery status of the message to be recalled may exist. In the first method, the delivery status of the message to be recalled is acquired based on a message tracking mechanism. In the second method, the delivery status of the message to be recalled is acquired based on a DSN and/or MDN mechanism.

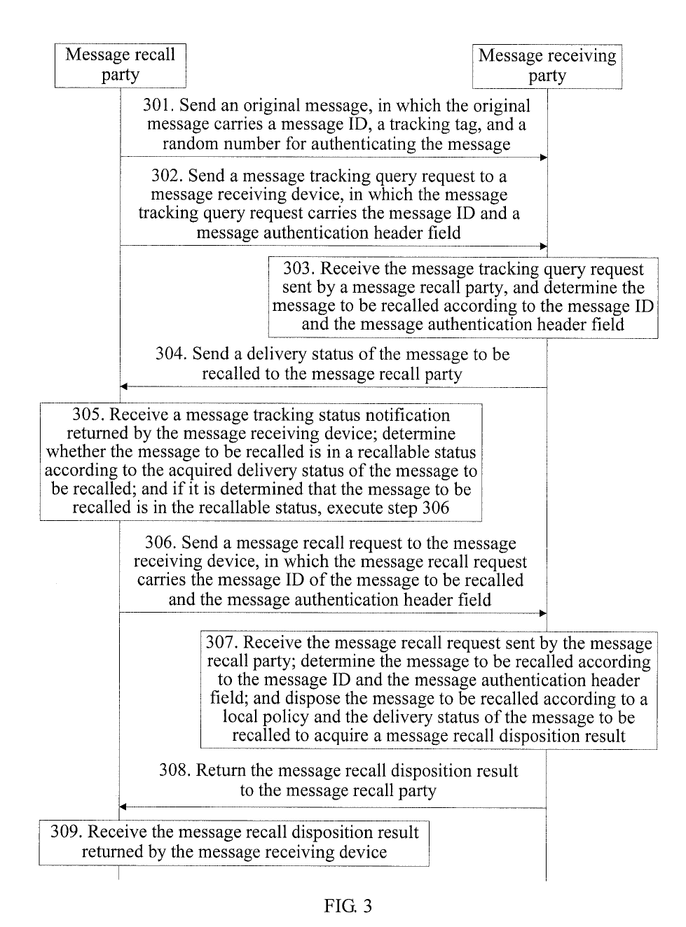

The embodiment of the present invention provides a method for recalling a message. The method for recalling the message is specifically described by taking the process of acquiring the delivery status of the message to be recalled based on the message tracking mechanism as an example. As shown in FIG. 3, the method specifically includes the following steps.

Step 301: Send an original message, in which the original message carries a message ID, a tracking tag, and a random number for authenticating the message.

When the original message is sent, in order to enable the message to be tracked, a Message Tracking tag needs to be added in the original message, that is, an MTRK command is used. Timeout information may be carried in the MTRK command to indicate tracking time to be saved by a relay server or a receiving party device. Within the tracking time, the server needs to save and record relevant information of the original message for the convenience of tracking. If specified time is exceeded, the message cannot be tracked.

The random number may be a GUID value on which a Hash algorithm is not performed and is not limited in the embodiment of the present invention, but relative uniqueness needs to be ensured, that is, others cannot predict the random number. Generation of the GUID is not specifically specified in the present invention. Since senders are located in different domains of different domain names, as long as a sending domain server can generate a unique ID in a local domain plus the domain name, global uniqueness can be implemented.

The message ID may be a Message-ID or an Original-Envelope-Id, as long as uniqueness is maintained, that is, a message can be accurately identified. The message ID is not limited in the embodiment of the present invention.

Step 302: A message recall party sends a message tracking query request to the message receiving device, in which the message tracking query request carries the message ID and a message authentication header field, and the message authentication header field includes an encryption algorithm and a random number generated by encrypting a random number for authenticating the message through the encryption algorithm. For the message authentication header field, reference may be made to step 1 in FIG. 1, and details are no longer described herein again.

Step 303: Receive the message tracking query request sent by the message recall party, in which the message tracking query request carries the message ID and the message authentication header field, determine the message to be recalled according to the message ID and the message authentication header field, and acquire a delivery status of the message to be recalled.

The specific operation of determining the message to be recalled according to the message ID and the message authentication header field is: identifying the message to be recalled according to the message ID; parsing the message to be recalled to acquire the random number for authenticating the message; encrypting the random number for authenticating the message through the encryption algorithm in the message authentication header field to acquire encrypted data; if the acquired encrypted data is equal to the encrypted random number in the message authentication header field, determining the identified message as the message to be recalled.

The delivery status of the message generally includes, but is not limited to, the following statuses:

“failed”: This status indicates that the message cannot be delivered to the receiving party, a reporting Message Transfer Agent (MTA) already gives up trying to deliver the message to the receiving party, and no subsequent notification exists.

“delayed”: This status indicates that the reporting MTA cannot deliver or relay the message, but will continue trying, and if the message continues to be delayed or is successfully delivered, or delivery attempt thereof is given up, additional notification messages may be sent.

“delivered”: This status indicates that the message is already successfully delivered to a receiving address, including a designated mail list, designated by the sending party, but does not indicate whether the message is read, which is a last status, so a subsequent notification should not be expected.

“relayed”: This status indicates that the message is already relayed to other entities, and this entity is no longer responsible for generating subsequent notifications when the message is successfully delivered. This action value should not be used unless the sending party requests the receiving party to send the notification when receiving the message successfully.

“expanded”: This status indicates that the message is already delivered to the receiving address specified by the sending party, and the reporting MTA already delivers this object to multiple appended receiving addresses. The action values “Expanded” and “Delivered” are different, since “Expanded” is not a final status and additional “Failed” or “Delayed” notification may be provided.

“transferred”: This status indicates that the message is already transferred to another MTA. A tracking agent should try to continue sending a tracking request to a next MTA.

“opaque”: This status indicates that a status of the message stays unknown. Subsequent information is not required.

Step 304: Carry the acquired delivery status of the message in a message tracking status notification and send the message tracking status notification to the message recall party.

Step 305: Receive the message tracking status notification returned by the message receiving device, in which the message tracking status notification carries the delivery status of the message to be recalled; determine whether the message to be recalled is in a recallable status according to the acquired delivery status of the message to be recalled; if it is determined that the message to be recalled is in the recallable status, execute step 306; and if it is determined that the message to be recalled is in a non-recallable status, stop the message recall process.

The delivery status of the message to be recalled may include the statuses described in step 303. Generally, if the message to be recalled is in the “delayed” status, it indicates that the message is not sent to the receiving party and the message can be recalled. If the message to be recalled is in the “delivered” status, it indicates that the message is already sent to the receiving party and generally cannot be recalled, but if the message is not read by the receiving party, the message can still be recalled. If the message to be recalled is in the “failed” status, it indicates that delivery fails and recall is unnecessary. If the message to be recalled is in the “relayed”, “expanded”, “transferred”, or “opaque” status, the message generally cannot be recalled, but if the message is not read by the receiving party, the message can still be recalled. In a message system, after reading the message, the receiving party sets a read status for the message, and the read status is synchronized to a receiving party server. If the receiving party operates directly on the receiving party server, synchronization is not needed, and the receiving party server can directly set a read status tag. Which statuses are recallable statuses and which statuses are non-recallable statuses specifically depend on policy setting of the sending party and are not limited in the embodiment of the present invention.

Step 306: Send the message recall request to the message receiving device, in which the message recall request carries the message ID of the message to be recalled and the message authentication header field, and the message authentication header field includes the encryption algorithm and the random number generated by encrypting the random number for authenticating the message through the encryption algorithm.

Step 307: Receive the message recall request sent by the message recall party, in which the message recall request carries the message ID of the message to be recalled and the message authentication header field; determine the message to be recalled according to the message ID and the message authentication header field, and acquire the delivery status of the message to be recalled; dispose the message to be recalled according to a local policy and the delivery status of the message to be recalled to acquire a message recall disposition result.

Specifically, the disposing the message to be recalled according to the local policy and the delivery status of the message to be recalled to acquire the message recall disposition result is: determining whether a message receiving end supports a message recall mechanism; determining whether the receiving end allows the message to be recalled; if the message receiving device supports the message recall mechanism and allows the message to be recalled, further determining whether the status of the message is the recallable status; if the message is in the recallable status, deleting the message; if the message is in the non-recallable status, returning a disposition result of a recall failure; if the message receiving device does not support the message recall mechanism, returning a disposition result of a message recall error.

In the message system, the receiving party can perform settings on the receiving party server to indicate whether the receiving party wants or allows a message sent to the receiving party to be recalled based on a setting policy of the receiving party. For example, it can indicate that no messages can be recalled, messages of some sending parties cannot be recalled, messages in some periods of time cannot be recalled, or some messages of high important levels are not allowed to be recalled. Meanwhile, the receiving party server can also perform relevant settings, for example, to indicate that some receiving parties are allowed to recall the message and others are not allowed to recall the message. The policy setting depends on specific implementation of the receiving party and the receiving party server and shall not be construed as a limit to the present invention.

For the specific operation of determining the message to be recalled according to the message ID and the message authentication header field, reference may be made to the relevant description in step 303, and details are no longer described herein again.

The message recall disposition result generally includes, but is not limited to, the following statuses: OK, in which the recall request succeeds, and the message is recalled; NO, in which the recall request fails, and the notification message may include some texts readable by the user and explaining the reason of failure; BAD, in which a server in an SMTP store-and-forward path does not support the Recall (RECL) protocol.

When the recall request fails, that is, a target message does not exist, the message receiving device does not allow the message to be recalled, or the original message is already read by the receiving party, a message recall result is shown as “NO”. When the message receiving device does not support the message recall mechanism, the message recall disposition result is “BAD”. When the message receiving device supports the message recall mechanism and allows the message to be recalled, and the message is in the recallable status, the message is deleted at the receiving side, and the message recall result is returned as “OK”.

The disposing the message to be recalled according to the local policy and the delivery status of the message to be recalled and returning the message recall disposition result to the message recall party may specifically include, but is not limited to, the following modes.

If it is determined that a recall property is not supported, a DSN notification message “BAD” is replied.

If it is determined that the target message does not exist, a DSN notification message “NO” is replied.

If it is determined that the message has not been sent to the receiving party, the message is deleted, and a DSN notification message “OK” is replied.

If it is determined that the local policy does not allow the message to be recalled, the DSN notification message “NO” is replied.

If it is determined that the original message is already tagged as read, the message cannot be recalled, and the DSN notification message “NO” is replied.

If it is determined that the original message cannot be recalled due to other reasons, the DSN notification message is replied “NO”.

If none of above items is applicable, the message is deleted, and the “OK” DSN notification message is replied.

Step 308: Return the message recall disposition result to the message recall party.

Step 309: Receive the message recall disposition result returned by the message receiving device.

In the embodiment of the present invention, the message sending party sends the message recall request to the message receiving device, in which the message recall request carries the message ID of the message to be recalled and the message authentication header field. When receiving the message recall request, the message receiving device determines the message to be recalled according to the message ID and the message authentication header field, acquires the delivery status of the message to be recalled, disposes the message to be recalled according to the local policy and the delivery status of the message to be recalled, and returns the message recall disposition result to the message recall party, so message recall is implemented, and the message sent by mistake can be recalled in time, so that the receiving party may not view the recalled messages, thereby improving a service quality of a message service. Since the message recall request is not limited by a private mail system, each mail system can send and receive the message recall request, so that the message recall demand is satisfied in an open, intercommunicated, and efficient manner, and the message to be recalled can be recalled in time, thereby improving the service quality of the message service.

Moreover, in the embodiment of the present invention, when the sent original message needs to be recalled, the delivery status of the message to be recalled may be first acquired, and then it is determined whether the message to be recalled can be recalled according to the delivery status of the message to be recalled, so that the message recall is more targeted, further improving efficiency of the message recall.

### Embodiment 3

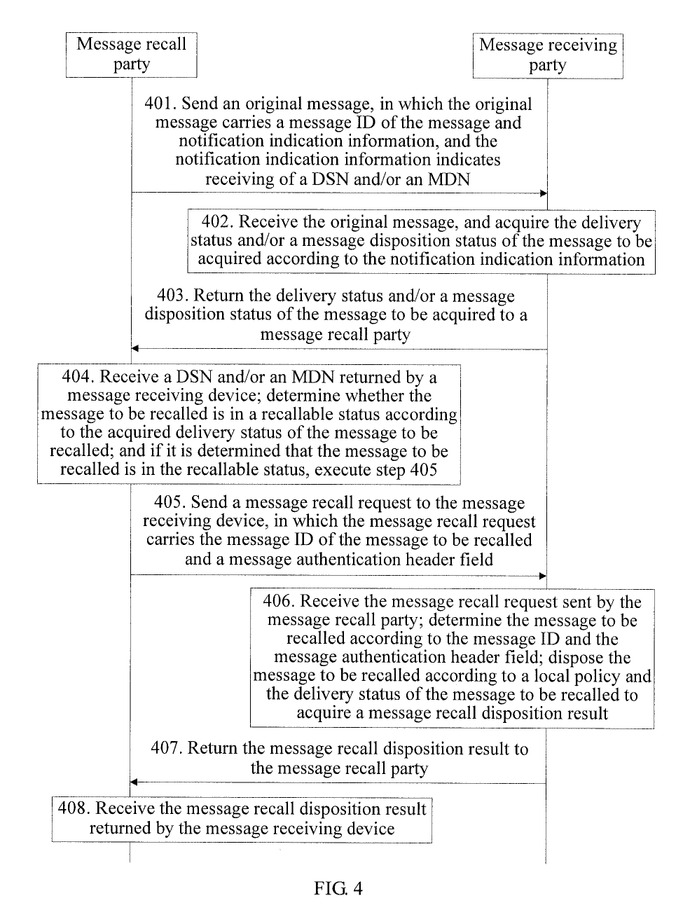

The embodiment of the present invention provides a method for recalling a message. The method for recalling the message is specifically described by taking the process of acquiring a delivery status of the message to be recalled according to a DSN and/or MDN mechanism as an example. As shown in FIG. 4, the method specifically includes the following steps.

Step 401: Send an original message, in which the original message carries a message ID of the message and notification indication information, and the notification indication information indicates receiving of a delivery status notification and/or a message disposition notification.

The delivery status notification is implemented based on a DSN (Delivery Status Notification) technology. For status indication, reference may be made to relevant description in step 303 in FIG. 3, and the difference is that the “transferred” status and the “opaque” status do not exist. Details are no longer described herein again.

The message disposition notification is implemented based on an MDN (Message Disposition Notification) technology. The message disposition notification mainly includes the following information: a disposition mode and a disposition type.

The disposition mode is classified into an action-mode and a sending-mode. The action mode is mainly classified into a manual-action mode and an automatic-action mode. The manual-action mode refers to a manual action indicated by a user, and the automatic-action mode refers to an automatic action not indicated by the user. The manual-action mode and the automatic-action mode are mutually exclusive, and either of the manual-action mode and the automatic-action mode must exist. The sending mode is mainly classified into an MDN-sent-manually mode and an MDN-sent-automatically mode. The MDN-sent-automatically mode is configured in advance, and the MDN-sent-manually mode is indicated by the user, for example, a user selects “Send Read Receipt” on a user interface when reading the message.

The disposition type mainly includes “displayed” and “deleted”. “Displayed” indicates that the message is displayed in a mail box of a receiving party and it is not ensured that message contents are read or understood. “Deleted” indicates that the message is deleted, a recipient may or may not read the message or may reclaim a deleted message from a trash bin and read the message. The disposition type indicates the delivery status of the message to be recalled, so that message receiving equipment feeds back the delivery status of the message to message sending equipment when receiving the message.

Step 402: Receive the original message, in which the original message carries the message ID of the message and notification indication information, and the notification indication information indicates receiving of the delivery status notification and/or the message disposition notification; and acquire the delivery status and/or a message disposition status of the message to be acquired according to the notification indication information.

Step 403: Return the delivery status notification and/or the message disposition notification of the message to a message recall party according to the notification indication information, so as to indicate the delivery status of the message.

Step 404: Receive the delivery status notification and/or the message disposition notification returned by a message receiving device, in which the delivery status notification and/or the message disposition notification indicates the delivery status of the message to be recalled; determine whether the message to be recalled is in a recallable status according to the acquired delivery status of the message to be recalled; if it is determined that the message to be recalled is in the recallable status, execute step 405; if it is determined that the message to be recalled is in a non-recallable status, stop the message recall process.

The recallable status or the non-recallable status of the message to be recalled is determined according to the delivery status notification and/or the message disposition notification. In which status the message can be recalled and in which status the message cannot be recalled are specifically set by the user and not limited in the embodiment of the present invention. For example, a “displayed” or “deleted” message generally cannot be recalled, and upon receiving this kind of notification, a sending party gives up message recall. For example, a “delivered” message can generally be recalled, and upon receiving this kind of notification, the sending party can send a message recall request to request the message recall.

Step 405: Send the message recall request to the message receiving device, in which the message recall request carries the message ID of the message to be recalled and a message authentication header field, and the message authentication header field includes an encryption algorithm and a random number generated by encrypting a random number for authenticating the message through the encryption algorithm.

Step 406: Receive the message recall request sent by the message recall party, in which the message recall request carries the message ID of the message to be recalled and the message authentication header field; determine the message to be recalled according to the message ID and the message authentication header field, and acquire the delivery status of the message to be recalled; dispose the message to be recalled according to a local policy and the delivery status of the message to be recalled to acquire a message recall disposition result.

The processes of determining and disposing the message to be recalled are specifically described in step 308 in FIG. 3 and are no longer described herein again.

Step 407: Return the message recall disposition result to the message recall party.

Step 408: Receive the message recall disposition result returned by the message receiving device.

In the embodiment of the present invention, a message sending party sends the message recall request to the message receiving device, in which the message recall request carries the message ID of the message to be recalled and the message authentication header field. When receiving the message recall request, the message receiving device determines the message to be recalled according to the message ID and the message authentication header field, acquires the delivery status of the message to be recalled, disposes the message to be recalled according to the local policy and the delivery status of the message to be recalled, and returns the message recall disposition result to the message recall party, so the message recall is implemented, and the message sent by mistake can be recalled in time, so that the receiving party may not view the recalled messages, thereby improving a service quality of a message service. Since the message recall request is not limited by a private mail system, each mail system can send and receive the message recall request, so that the message recall demand is satisfied in an open, intercommunicated, and efficient manner, and the message to be recalled can be recalled in time, thereby improving the service quality of the message service.

Moreover, in the embodiment of the present invention, when the sent original message needs to be recalled, the delivery status of the message to be recalled may be first acquired, and then it is determined whether the message to be recalled can be recalled according to the delivery status of the message to be recalled, so that the message recall is more targeted, further improving the efficiency of the message recall.

Furthermore, in some embodiments of the present invention, after returning the recall disposition result of the message to be recalled to the message recall party, a receiving party device also sends message recall information of the message recall party to a message receiving party, so that the message receiving party can know message disposition of the message sending party, in which the message recall information includes a message recall occurrence time and a message recall result. When the function is implemented, the message recall party generally carries a notification setting in the message recall request when sending the message recall request, in which the notification setting is used to indicate whether the message receiving device sends a recall information notification to the receiving party, and the notification setting may include, but is not limited to, the following optional values:

NO: This optional value indicates that the receiving party is never notified of the recall request.

FAILURE: This optional value indicates that the receiving party is notified of the recall request only if the recall request fails. The receiving party can be notified that the sending party tries to revoke the message, but the message actually fails to be revoked.

SUCCESS: This optional value indicates that the receiving party is notified of the recall request only if the recall request succeeds. This optional value can be used for replacing a recalled target message with a notification message, so that the receiving party is notified that the original message is revoked.

ALL: This optional value indicates that no matter the recall request succeeds or not, the receiving party is notified of the recall request.

The mechanism for notifying the receiving party depends on implementation. The receiving party may be notified by using an e-mail message or other notification mechanisms available locally, and the notification mechanism is not limited in the embodiment of the present invention.

Furthermore, if the original message is stolen by an eavesdropper, the eavesdropper may add or modify the message authentication header field. In this case, an unauthorized entity might implement the message recall. Therefore, in order to ensure the security of the message recall, when the message recall request is sent to the message receiving device, the method further includes setting a security mechanism for the message recall. The setting of the security mechanism may include, but is not limited to, the following two manners: setting a security mechanism of message recall timeout and setting a security mechanism of enabling or disabling a message recall function. Furthermore, if a sending domain rather than a sending user agent generates the message authentication header field, the sending domain must provide a GUID required by an RECL command. The present invention does not provide a mechanism for authenticating the user sending the recall request, so the sending domain should be responsible for authenticating whether the user has the permission to send the recall request, for example, by authenticating a user name and a password of the user. If the recall message is received before the original message, for example, the user recalls a message immediately after sending the message, the sending party server should buffer the recall message, and the original message can be deleted upon arrival. In some cases, message recall is not allowed, for example, in some legal situations, so an enable/disable option is provided for a mail box or a message box, so as to enable or disable the message recall property. For some messages that cannot be recalled or are not allowed to be recalled, the Message-ID may not be carried in the original message, so that the original message cannot be recalled. Furthermore, in order to prevent a Message Tracking mechanism from being used to violate the privacy of others, a timeout mechanism needs to be set, so that a Message Tracking message is not allowed to be sent repeatedly within a specified period of time.

### Embodiment 4

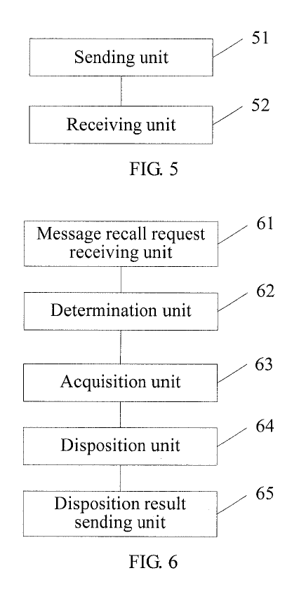

An embodiment of the present invention provides a message sending device. As shown in FIG. 5, a sending party device includes a sending unit 51 and a receiving unit 52.

The sending unit 51 is configured to send a message recall request to a message receiving device, in which the message recall request carries a message ID of a message to be recalled and a message authentication header field, and the message authentication header field includes an encryption algorithm and a random number generated by encrypting a random number for authenticating the message through the encryption algorithm, so that the message receiving device determines the message to be recalled according to the message ID and the message authentication header field, and disposes the message to be recalled according to a local policy and a delivery status of the message to be recalled; and the message authentication header field corresponds to a message ID header field, and if a message sending party supports the present invention and wishes that the message sent thereby can be recalled, when the sending party sends the message, the message ID header field is included in an original message, and a random number for authenticating the message is saved in the message ID header field.

After the sending unit 51 sends the message recall request to the message receiving device, the receiving unit 52 is configured to receive a message recall disposition result returned by the message receiving device. The message recall disposition result may include, but is not limited to, a message recall error, a message recall success, and a message recall failure. When the message recall error is returned, an error reason may also be added, and when the message recall failure is returned, a failure reason may also be added. The form of the message recall disposition result is not limited in the embodiment of the present invention and can be set by a user according to the requirements in a specific embodiment.

An embodiment of the present invention also provides a message receiving device. As shown in FIG. 6, a receiving party device includes a message recall request receiving unit 61, a determination unit 62, an acquisition unit 63, a disposition unit 64, and a disposition result sending unit 65.

The message recall request receiving unit 61 is configured to receive a message recall request sent by a message sending device, in which the message recall request carries a message ID of a message to be recalled and a message authentication header field, and the message authentication header field includes an encryption algorithm and a random number generated by encrypting a random number for authenticating the message through the encryption algorithm. After the message recall request is received, the determination unit 62 is configured to determine the message to be recalled according to the message ID and the message authentication header field received by the message recall request receiving unit 61.

After the message to be recalled is determined, the acquisition unit 63 is configured to acquire a delivery status of the message to be recalled determined by the determination unit, the disposition unit 64 is configured to dispose the message to be recalled according to a local policy and the delivery status of the message to be recalled acquired by the acquisition unit 63 to acquire a message recall disposition result, and the disposition result sending unit 65 is configured to return the message recall disposition result acquired by the disposition unit 64 to a message recall sending party.

In the embodiment of the present invention, the message sending device sends the message recall request to the message receiving device, in which the message recall request carries the message ID of the message to be recalled and the message authentication header field. When receiving the message recall request, the message receiving device determines the message to be recalled according to the message ID and the message authentication header field, acquires the delivery status of the message to be recalled, disposes the message to be recalled according to the local policy and the delivery status of the message to be recalled, and returns the message recall disposition result to the message recall party, so the message recall is implemented, and the message sent by mistake can be recalled in time, so that the receiving party may not view the recalled messages, thereby improving a service quality of a message service. Since the message recall request is not limited by a private mail system, each mail system can send and receive the message recall request, so that the message recall demand is satisfied in an open, intercommunicated, and efficient manner, and the message to be recalled can be recalled in time, thereby improving the service quality of the message service.

### Embodiment 5

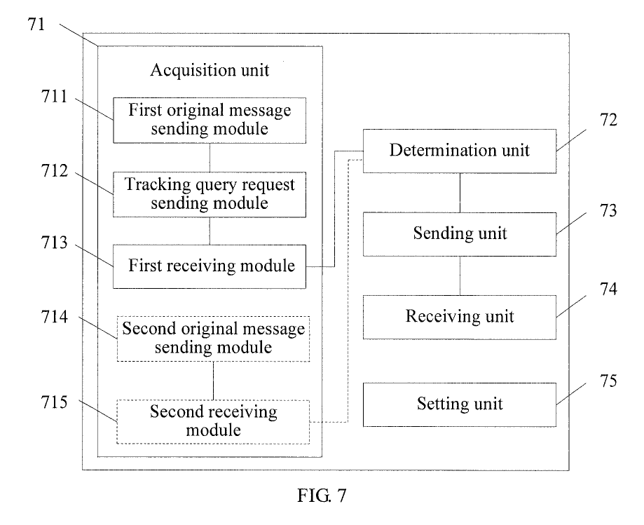

An embodiment of the present invention provides a message sending device. As shown in FIG. 7, a sending party device includes an acquisition unit 71, a determination unit 72, a sending unit 73, and a receiving unit 74.

Before the sending unit 73 sends a message recall request to a message receiving device, the acquisition unit 71 acquires a delivery status of a message to be recalled. The following two methods for the acquisition unit 71 to acquire the delivery status of the message to be recalled may exist. In the first method, the delivery status of the message to be recalled is acquired based on a message tracking mechanism. In the second method, the delivery status of the message to be recalled is acquired based on a DSN and/or MDN mechanism.

After the delivery status of the message to be recalled is acquired, the determination unit 72 is configured to determine whether the message to be recalled is in a recallable status according to the delivery status of the message to be recalled acquired by the acquisition unit 71. If it is determined that the message to be recalled is in a recallable status, the determination unit 72 invokes the sending unit 73 to send the message recall request to the message receiving device, so as to recall the message to be recalled, in which the message recall request carries a message ID of a message to be recalled and a message authentication header field, and the message authentication header field includes an encryption algorithm and a random number generated by encrypting a random number for authenticating the message through the encryption algorithm, so that the message receiving device determines the message to be recalled according to the message ID and the message authentication header field, and disposes the message to be recalled according to a local policy and the delivery status of the message to be recalled. After the message recall request is sent to the message receiving device, the receiving unit 74 is configured to receive a message recall disposition result returned by the message receiving device, thereby implementing message recall.

If the determination unit 72 determines that the message to be recalled is in a non-recallable status, the message recall process needs to be stopped.

The acquisition unit 71 is configured to acquire the delivery status of the message to be recalled. When a message recall receiving party device acquires the delivery status of the message to be recalled based on the message tracking mechanism, the acquisition unit 71 includes a first original message sending module 711, a tracking query request sending module 712, and a first receiving module 713. When the acquisition unit 71 is configured to acquire the delivery status of the message to be recalled based on the message tracking mechanism, the first original message sending module 711 first carries the message ID of the message, a tracking tag, and the random number for authenticating the message in an original message when sending the original message.

When the sent original message needs to be recalled, the tracking query request sending module 712 sends a message tracking query request to the receiving party device of the message to be recalled, in which the message tracking query request carries the message ID and the message authentication header field, and the message authentication header field includes the encryption algorithm and the random number generated by encrypting the random number for authenticating the message through the encryption algorithm. The first receiving module 713 receives a message tracking status notification returned by the message receiving device, in which the message tracking status notification carries the delivery status of the message to be recalled.

When the message recall receiving party device acquires the delivery status of the message to be recalled based on the DSN and/or the MDN mechanism, the acquisition unit 71 includes a second original message sending module 714 and a second receiving module 715. When the acquisition unit 71 acquires the delivery status of the message to be recalled based on the DSN and/or the MDN mechanism, first, the second original message sending module 714 carries the message ID of the message and notification indication information in the original message when sending the original message, in which the notification indication information indicates receiving of a delivery status notification and/or a message disposition notification. The second receiving module 715 is configured to receive the delivery status notification and/or the message disposition notification returned by the message receiving device, in which the delivery status notification and/or the message disposition notification indicates the delivery status of the message to be recalled.

Furthermore, in some embodiments of the present invention, after returning the recall disposition result of the message to be recalled to the message recall party, the receiving party device also sends message recall information to a message receiving party, so that the message receiving party can know message disposition of the message sending party. When the function is implemented, the message recall party generally carries a notification setting in the message recall request sent by the sending unit 73 when sending the message recall request, in which the notification setting is used to indicate whether the message receiving device sends a recall information notification to the receiving party.

Furthermore, if when being delivered, the original message is stolen by an eavesdropper, the eavesdropper may add or modify the message authentication header field. In this case, an unauthorized entity might implement the message recall. Therefore, in order to ensure the security of the message recall, when the message recall request is sent to the message receiving device, the message receiving device further includes a setting unit 75 configured to set a security mechanism for the message recall. The setting of the security mechanism may include, but is not limited to, the following two manners: setting a security mechanism of message recall timeout and setting a security mechanism of enabling or disabling a message recall function. The setting manner is not limited in the embodiment of the present invention, and any setting manner can be used in the embodiment of the present invention as long as the setting manner can ensure that the information to be recalled is recalled securely.

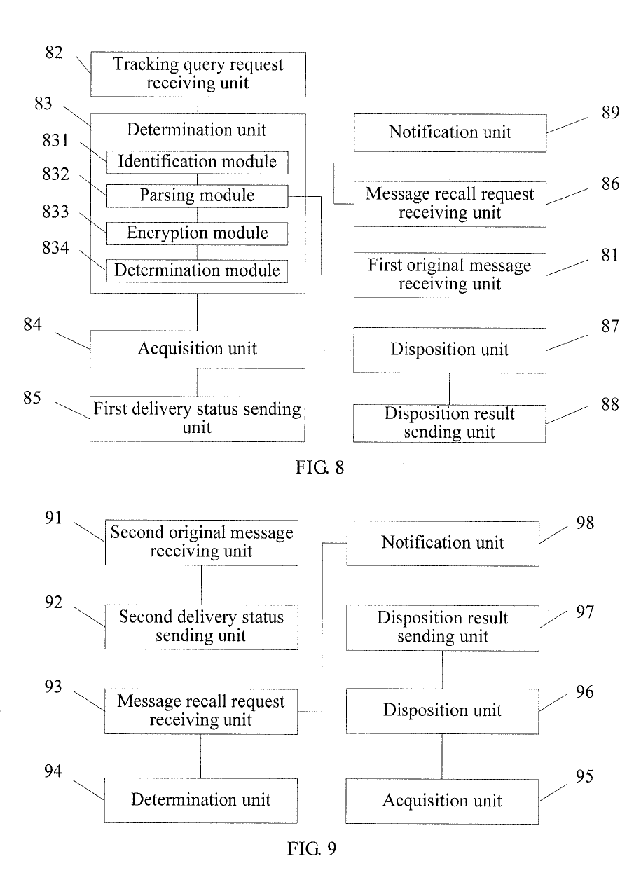

An embodiment of the present invention also provides a message receiving device, which corresponds to a message recall sending party device and acquires a delivery status of a message to be recalled based on a message tracking mechanism. As shown in FIG. 8, the device includes a first original message receiving unit 81, a tracking query request receiving unit 82, a determination unit 83, an acquisition unit 84, a first delivery status sending unit 85, a message recall request receiving unit 86, a disposition unit 87, and a disposition result sending unit 88.

The first original message receiving unit 81 is configured to receive an original message sent by a sending party device of a message recall party, in which the original message carries a message ID of the message, a tracking tag, and a random number for authenticating the message. In order to enable the message to be tracked, a Message Tracking tag needs to be added in the original message, that is, an MTRK command is used. Timeout information may be carried in the MTRK command to indicate tracking time to be saved by a relay server or a receiving party device. Within the tracking time, the server needs to save and record relevant information of the original message for the convenience of tracking. If a specified time is exceeded, the message cannot be tracked.

When the message recall party decides to recall the sent original message and a message recall sending party sends a tracking query request to the message receiving party device, the tracking query request receiving unit 82 is configured to receive the message tracking query request sent by a message sending device, in which the message tracking query request carries the message ID and a message authentication header field. After the tracking query request is received, the determination unit 83 determines the message to be recalled according to the message ID and the message authentication header field received by the tracking query request receiving unit 82. After the message to be recalled is determined, the acquisition unit 84 is configured to acquire the delivery status of the message to be recalled determined by the determination unit 83, and the first delivery status sending unit 85 carries the delivery status of the message to be recalled acquired by the acquisition unit 84 in a message tracking status notification and sends the message tracking status notification to the message recall sending party device.

After the message sending device determines that the message to be recalled is in a recallable status according to the delivery status of the message to be recalled sent by the first delivery status sending unit 85 of the message receiving device, and when the message sending device sends a message recall request to the message receiving device, the message recall request receiving unit 86 is configured to receive the message recall request, in which the message recall request carries the message ID of the message to be recalled and the message authentication header field. After the message recall request is received, the determination unit 83 is further configured to determine the message to be recalled according to the message ID and the message authentication header field received by the receiving unit, and the acquisition unit 84 is further configured to acquire the delivery status of the message to be recalled determined by the determination unit 83. After the message to be recalled is determined, the disposition unit 87 is configured to dispose the message to be recalled according to a local policy and the delivery status of the message to be recalled to acquire a recall disposition result of the message to be recalled, and the disposition result sending unit 88 returns a message recall disposition result disposed by the disposition unit to the message sending device.

When the message sending device carries a notification setting in the sent message recall request, the message receiving device further includes a notification unit 89 configured to send a message recall information notification to the message receiving party according to the notification setting, so that the receiving party of the original message can know a recall operation performed by a message recall party device on the original message.

The determination unit 83 includes an identification module 831, a parsing module 832, an encryption module 833, and a determination module 834.

When the determination unit 83 determines the message to be recalled according to the message ID and the message authentication header field received by the receiving unit, the identification module 831 is configured to identify the message to be recalled according to the message ID; the parsing module 832 is configured to parse the message to be recalled to acquire the random number for authenticating the message; the encryption module 833 is configured to encrypt the random number for authenticating the message through the encryption algorithm in the message authentication header field to acquire encrypted data; the determination module 834 is configured to determine the identified message as the message to be recalled when the encrypted data acquired by the encryption module 833 is equal to the encrypted random number in the message authentication header field.

An embodiment of the present invention also provides a message receiving device, which corresponds to a message recall sending party device and acquires a delivery status of a message to be recalled according to a DSN and/or MDN mechanism. As shown in FIG. 9, the device includes a second original message receiving unit 91, a second delivery status sending unit 92, a message recall request receiving unit 93, a determination unit 94, an acquisition unit 95, a disposition unit 96, and a disposition result sending unit 97.

The second original message receiving unit 91 is configured to receive an original message, in which the original message carries a message ID of the message and notification indication information, and the notification indication information indicates receiving of a delivery status notification and/or an message disposition notification. The second delivery status sending unit 92 is configured to return the delivery status notification and/or the message disposition notification of the message to a message recall party according to the notification indication information received by the second original message receiving unit 91, so as to indicate the delivery status of the message.

After a message sending device determines that the message to be recalled is in a recallable status according to the delivery status of the message to be recalled sent by the second delivery status sending unit 92 of a message recall device, and when the message sending device sends a message recall request to the message recall device, the message recall request receiving unit 93 is configured to receive the message recall request, in which the message recall request carries the message ID of the message to be recalled and the message authentication header field. After the message recall request is received, the determination unit 94 is further configured to determine the message to be recalled according to the message ID and the message authentication header field received by the receiving unit 93, and the acquisition unit 95 is further configured to acquire the delivery status of the message to be recalled determined by the determination unit 94. After the message to be recalled is determined, the disposition unit 96 is configured to dispose the message to be recalled according to a local policy and the delivery status of the message to be recalled to acquire a recall disposition result of the message to be recalled, and the disposition result sending unit 97 returns a message recall disposition result disposed by the disposition unit to the message sending device.

When the message sending device carries a notification setting in the sent message recall request, the message receiving device further includes a notification unit 98 configured to send a message recall information notification to the message receiving party according to the notification setting, so that the receiving party of the original message can know a recall operation preformed by a message recall party device on the original message.

The specific operation for the determination unit 94 to determine the message to be recalled according to the message ID and the message authentication header field is the same as that described for the determination unit 83 in FIG. 8, and is no longer described herein again.

In the embodiment of the present invention, a message sending party sends the message recall request to the message receiving device, in which the message recall request carries the message ID of the message to be recalled and the message authentication header field. When receiving the message recall request, the message receiving device determines the message to be recalled according to the message ID and the message authentication header field, acquires the delivery status of the message to be recalled, disposes the message to be recalled according to the local policy and the delivery status of the message to be recalled, and returns the message recall disposition result to the message recall party, so the message recall is implemented, and the message sent by mistake can be recalled in time, so that the receiving party may not view the recalled messages, thereby improving a service quality of a message service. Since the message recall request is not limited by a private mail system, each mail system can send and receive the message recall request, so that the message recall demand is satisfied in an open, intercommunicated, and efficient manner, and the message to be recalled can be recalled in time, thereby improving the service quality of the message service.

Moreover, in the embodiment of the present invention, when the sent original message needs to be recalled, the delivery status of the message to be recalled may be first acquired, and then it is determined whether the message to be recalled can be recalled according to the delivery status of the message to be recalled, so that the message recall is more targeted, further improving the efficiency of the message recall.

For the interaction between elements provided in the message sending device and the message receiving device according to the embodiments of the present invention and relevant information, reference may be made to the processes provided in the method embodiments, and for the specific functions and processing flows, reference may be made to the embodiments. Details are no longer described herein again.

The present invention is applicable to emails and all kinds of messages, including a voice message, a text message, and a video message, so the messages are not distinguished and collectively called messages. In the present invention, the recall may also refer to revoking or reclaiming, but is collectively called recall. The difference in terms should not be constructed as a limit to the present invention.

Through the above description of the embodiments, it is apparent to persons skilled in the art that the present invention may be accomplished by software plus necessary universal hardware, and definitely may also be accomplished by hardware, but in most cases, the present invention is preferably implemented through software plus necessary universal hardware. Based on this, the technical solution of the present invention or the part that makes contributions to the prior art can be substantially embodied in the form of a software product. The computer software product may be stored in the readable storage media, for example, a floppy disk, hard disk, or optical disk of the computer, and include several instructions used for instructing computer equipment (for example, a personal computer, a server, or network equipment) to perform the method according to the embodiments of the present invention.

In conclusion, the above are merely exemplary embodiments of the present invention. However, the scope of the present invention is not limited thereto. Changes or replacements readily apparent to persons skilled in the prior art within the technical scope of the present invention should fall within the scope of the present invention. Therefore, the protection scope of the present invention is subject to the appended claims.

What is claimed is:

1. A method for recalling a message, comprising:
sending a message recall request to a message receiving device, wherein the message recall request carries a message identifier (ID) of a message to be recalled and a message authentication header field, and the message authentication header field comprises an encryption algorithm and a random number generated by encrypting a random number for authenticating the message through the encryption algorithm, so that the message receiving device determines the message to be recalled according to the message ID and the message authentication header field, and disposes the message to be recalled according to a local policy and a delivery status of the message to be recalled; and
receiving a message recall disposition result returned by the message receiving device.

2. The method for recalling a message according to claim 1, wherein before the sending the message recall request to the message receiving device, the method further comprises:
acquiring the delivery status of the message to be recalled;
determining whether the message to be recalled is in a recallable status according to the acquired delivery status of the message to be recalled; and
if it is determined that the message to be recalled is in the recallable status, sending the message recall request to the message receiving device.

3. The method for recalling a message according to claim 2, wherein the acquiring the delivery status of the message to be recalled comprises:
acquiring the delivery status of the message to be recalled based on a message tracking mechanism; or acquiring the delivery status of the message to be recalled based on a Delivery Status Notification (DSN) and/or Message Disposition Notification (MDN) mechanism.

4. The method for recalling a message according to claim 3, wherein the acquiring the delivery status of the message to be recalled based on the message tracking mechanism specifically comprises:
when sending an original message, carrying the message ID of the message, a tracking tag, and the random number for authenticating the message in the original message;
sending a message tracking query request to a receiving party device of the message to be recalled, wherein the message tracking query request carries the message ID and the message authentication header field; and
receiving a message tracking status notification returned by the message receiving device, wherein the message tracking status notification carries the delivery status of the message to be recalled.

5. The method for recalling a message according to claim 3, wherein the acquiring the delivery status of the message to be recalled based on the DSN and/or MDN mechanism specifically comprises:
when sending an original message, carrying the message ID of the message and notification indication information in the original message; and
receiving a delivery status notification and/or a message disposition notification returned by the message receiving device according to the notification indication information, wherein the delivery status notification and/or the message disposition notification indicates the delivery status of the message to be called.

6. The method for recalling a message according to claim 1, wherein when sending the message recall request to the message receiving device, the message recall request further carries a notification setting, and the notification setting is used to indicate whether the message receiving device sends a recall information notification to a receiving party.

7. The method for recalling a message according to claim 6, wherein the notification setting comprises any one of the following parameters:
never notifying the receiving party of the recall request, notifying the receiving party of the recall request only if the recall request fails, notifying the receiving party of the recall request only if the recall request succeeds, and notifying the receiving party of the recall request no matter the recall request succeeds or not.

8. The method for recalling a message according to claim 1, wherein when sending the message recall request to the message receiving device, the method further comprises:
setting a security mechanism of message recall timeout; or setting a security mechanism of enabling or disabling a message recall function.

9. A method for recalling a message, comprising:
receiving a message recall request, wherein the message recall request carries a message identifier (ID) of a message to be recalled and a message authentication header field, and the message authentication header field comprises an encryption algorithm and a random number generated by encrypting a random number for authenticating the message through the encryption algorithm;
determining the message to be recalled according to the message ID and the message authentication header field; and
disposing the message to be recalled according to a local policy and a delivery status of the message to be recalled, and returning a message recall disposition result to a message recall party.

10. The method for recalling a message according to claim 9, wherein before receiving the message recall request, the method further comprises:
receiving an original message, wherein the original message carries the message ID of the message, a tracking tag, and the random number for authenticating the message; receiving a message tracking query request, wherein the message tracking query request carries the message ID and the message authentication header field; determining the message to be recalled according to the message ID and the message authentication header field; and carrying the determined delivery status of the message to be recalled in a message tracking status notification and sending the message tracking status notification to the message recall party; or
receiving an original message, wherein the original message carries the message ID of the message and notification indication information, and the notification indication information indicates receiving of a delivery status notification and/or a message disposition notification; and
returning the delivery status notification and/or the message disposition notification of the message to the message recall party according to the notification indication information, so as to indicate the delivery status of the message.

11. The method for recalling a message according to claim 9, wherein the determining the message to be recalled according to the message ID and the message authentication header field comprises:
identifying the message to be recalled according to the message ID;
parsing the message to be recalled to acquire the random number for authenticating the message;
encrypting the random number for authenticating the message through the encryption algorithm in the message authentication header field to acquire encrypted data; and
if the acquired encrypted data is equal to the encrypted random number in the message authentication header field, determining the identified message as the message to be recalled.

12. The method for recalling a message according to claim 10, wherein the determining the message to be recalled according to the message ID and the message authentication header field comprises:
identifying the message to be recalled according to the message ID;
parsing the message to be recalled to acquire the random number for authenticating the message;
encrypting the random number for authenticating the message through the encryption algorithm in the message authentication header field to acquire encrypted data; and
if the acquired encrypted data is equal to the encrypted random number in the message authentication header field, determining the identified message as the message to be recalled.

13. The method for recalling a message according to claim 9, wherein when the recall request comprises a notification setting and the notification setting is used to indicate whether the message receiving device sends a recall information notification to a receiving party, the method further comprises sending a message recall information notification to a message receiving party according to the notification setting.

14. A message sending device, comprising:
a sending unit, configured to send a message recall request to a message receiving device, wherein the message recall request carries a message identifier (ID) of a message to be recalled and a message authentication header field, and the message authentication header field comprises an encryption algorithm and a random number generated by encrypting a random number for authenticating the message through the encryption algorithm, so that the message receiving device determines the message to be recalled according to the message ID and the message authentication header field, and disposes the message to be recalled according to a local policy and a delivery status of the message to be recalled; and
a receiving unit, configured to receive a message recall disposition result returned by the message receiving device.

15. The message sending device according to claim 14, further comprising:
an acquisition unit, configured to acquire the delivery status of the message to be recalled before the sending unit sends the message recall request to the message receiving device; and
a determination unit, configured to determine whether the message to be recalled is in a recallable status according to the delivery status of the message to be recalled acquired by the acquisition unit, and invoke the sending unit to send the message recall request to the message receiving device if it is determined that the message to be recalled is in the recallable status.

16. The message sending device according to claim 14, further comprising:
a setting unit, configured to set a security mechanism of message recall timeout or set a security mechanism of enabling or disabling a message recall function when the sending unit sends the message recall request to the message receiving device.

17. A message receiving device, comprising:
a message recall request receiving unit, configured to receive a message recall request, wherein the message recall request carries a message identifier (ID) of a message to be recalled and a message authentication header field, and the message authentication header field comprises an encryption algorithm and a random number generated by encrypting a random number for authenticating the message through the encryption algorithm;
a determination unit, configured to determine the message to be recalled according to the message ID and the message authentication header field received by the message recall request receiving unit;
a disposition unit, configured to dispose the message to be recalled according to a local policy and a delivery status of the message to be recalled; and
a disposition result sending unit, configured to return a message recall disposition result disposed by the disposition unit to a message recall party.

18. The message receiving device according to claim 17, wherein when the message sending device acquires the delivery status of the message to be recalled based on a message tracking mechanism, the device further comprises: a first original message receiving unit, configured to receive an original message before the message recall request receiving unit receives the message recall request, wherein the original message carries the message ID of the message, a tracking tag, and the random number for authenticating the message;
a tracking query request receiving unit, configured to receive a message tracking query request, wherein the message tracking query request carries the message ID and the message authentication header field;
wherein the determination unit is further configured to determine the message to be recalled according to the message ID and the message authentication header field received by the tracking query request receiving unit;
a first delivery status sending unit, configured to carry the delivery status of the message to be recalled determined by the determination unit in a message tracking status notification and send the message tracking status notification to a message recall sending party.

19. The message receiving device according to claim 17, wherein when the message sending device acquires the delivery status of the message to be recalled based on a Delivery Status Notification (DSN) and/or a Message Disposition Notification (MDN) mechanism, the device further comprises:
a second original message receiving unit, configured to receive an original message before the message recall request receiving unit receives the message recall request, wherein the original message carries the message ID of the message and notification indication information; and
a second delivery status sending unit, configured to return a delivery status notification and/or an message disposition notification of the message to a message recall sending party according to the notification indication information received by the second original message receiving unit, so as to indicate the delivery status of the message.

20. The message receiving device according to claim 17, further comprising:
a notification unit, configured to send a message recall information notification to a message receiving party according to a notification setting when the message recall request received by the message recall request receiving unit comprises the notification setting.
